(19) United States
(12) Patent Application Publication
(10) Pub. No.: US 2016/0143458 A1
(43) Pub. Date: May 26, 2016

(54) Process of pre attaching to and carrying shopping bags on a bagholder in a stores carts, baskets and other similar devices so that the bags are always ready for use by customers during shopping with a scanning device, RFID or similar system in use at the store.

(71) Applicant: Carl Mattias Bremer, Helsinki (FI)

(72) Inventor: Carl Mattias Bremer, Helsinki (FI)

(21) Appl. No.: 14/551,012

(22) Filed: Nov. 23, 2014

(51) Int. Cl. A47F 10/02; B65D 33/00; G06Q 30/06

(52) U.S. Cl. CPC A47F 10/02; G06Q 30/0601; B65D 33/007; A47F 2010/005

(57) ABSTRACT

The invention and product form a process enhancement with which one in a simple way can guide the customer in order to increase profits in stores that utilize self, mobile or other type of automated scanning Shopping bags are attached and carried at all times by a bagholder product that attaches to a stores all baskets and carts simplifying things, effectivising and leading to financial gain.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

I have researched all or most store chains in the world in order to find the most solid and technologically advanced chains competing successfully. I have further researched what these particular chains are doing and what they can do or implement in order to become even better. When studying the most important aspects of a stores profits be it a chain or a single store some aspects become more important than others. These aspects arise through competitive advantages, technical and other innovations or a locationally superior place or area of the store/s.

“Roland Berger 2009 Convenience, Price and Diversity” are the 3 most important factors when a customer chooses a store “Convenience can be seen as depending on total time spent in shopping and on the value of the time spent (Roland Berger 2009)”. In this survey, spending shorter periods at the checkout was one of the most common answers to the question “What would you like to see in your store in the future?” And Accenture's 2014 study on 15,000 buying customers in 20 countries. (supporting the process improvement outcome here). “40 percent of respondents ranked improving the in-store customer experience as first, compared to just 16 percent who said the same of online shopping.” www.accenture.com/us-en/Pages/insight-accenture-seamless-retail-survey-2014.aspx

In Financial Times Jul. 7, 2014 there was an article on what big supermarket chains in the world are starting to do right now. Supermarkets are investing in effectivising, shrinking and increasing the convenience of their stores. This is true especially among discounters. Wal-Mart, Tesco, Aldi, Lidl, Morrison's, Sainsbury's, Carrefour etc. are all planning changes or additions. It has become evident that customers look for convenience not only the cheapest price as has been the thought earlier. The process at issue here leads to effectivising, shrinking and an increased convenience and more return or more pricing power in the most ecological way. The process is thus also in line with what the customer wants leading to possibly lower prices through process improvements and effectivising things.

### Jul. 6, 2014 Retail

Wheels coming off the supermarket trolley
Shift to discounters and small stores leads to refocusing
www.ft.com/cms/s/0/0a7150ea-fe1f-11e3-b4f1-00144feab7de.html

### Jul. 6, 2014 Retail

Supermarkets downsize for convenience
Race for space adapts to changing shopping habits
www.ft.com/cms/s/0/0f9ad0bc-01ff-11e4-9af7-00144feab7de.html

Many store chains are or have implemented self or mobile scanning in stores also some RFID solutions are taking form. When implementing self scanning the cashier function becomes redundant to a large part or it must in order for the process to be realized effectively. This can create direct savings. It does not necessarily mean making the cashier redundant but that is beyond the scope of this text (I have developed 2 concepts tackling this issue and increasing return further.). However to mention something I have developed 2 concepts that can increase the return in a store from around $44.000-$680.000,—or more which counterweighs the previously mentioned.

In the US Wal-mart is rolling out mobile scanning in 1200 stores. Kroger uses hand scanning in some of their stores as does Ahold and its subsidiaries as well and many more. Representing an enormous number of stores with hand scanning implemented.
“TESCO is launching self-scanning to 200 of their stores in the UK>
Self-scanning on smart phones at Coop Switzerland>
The first ever self-scanning project in the Middle East>
New customer in Ireland start using self scanning.
Carrefour—uses hand scanning in France, Belgium and Spain
Feneberg is the First German retailer to introduce self scanning
Mydin introduces Self-scanning in South-East Asia
EMTE—Implements a full solution suite
With over 10 years of experience the leading global provider of mobile self-scanning solutions holds the largest market share with 80.000 terminals live in a daily customer environment. With Carrefour, Tesco, Coop among our customers, we have a proven track record of delivering business value to the largest retail organizations.”

In Sweden ICA, Axfood and Coop are using hand scanning in many of their stores. Hand scanning also has many Italian users and is in use in many Italian chains sometimes even in all stores of a chain. Over the 10 years or more that hand scanning has been around it has slowly gained fraction globally. Scanning is also now enabled more cheaply for stores through the availability of mobile phone scanning.

When breaking down the cashier function paying takes a few seconds while handling the goods takes a minute or two. When researching the hand scanning process it took about 30 seconds or less on average to arrive at the point of payment with already loaded shopping bags check the hand scanning device, make payment and lift up the previously filled bag/s and leave. If the bags or items were not loaded the process took from 2-3 minutes, paying and bagging the items. This caused more queuing which lead to even more delays. Obviously a much larger space is required to cope with this glitch in the process. This glitch is proportionately very expensive in the light of the stores total area.

In stores with scanning implemented the utilization of the scanning devices has not always reached a high enough level. In 1 store chain with scanners in all larger stores the best utilization degree passes 50% but is also as low as 30% in stores* (*discussions). By using the Bagholder part and process one encourages the customer to shop in the most convenient and ecological way thus raising the utilization degree of the scanning This can have large additional financial benefits. In many stores the old cashier system is still in use or present. Customers need to be encouraged to use scanners. Furthermore there is no solution guaranteeing and guiding the customer to always scan and bag no matter the choice of “transportation” i.e. cart or bag. With a 30 second payment process time there can theoretically be 960 customers during 8 hours which corresponds to 120 customers in 1 hour for 1 payment machine. With the 3 minute time there can theoretically be 160 customers during 8 hours and 20 customers fit into 1 hour. It goes without saying that a faster and smoother process increases convenience enormously by shortening or eliminating queues, enabling more customers especially at peak hours and thus bringing more customers. This process improvement drastically reduces expensive space needed for idle customers.

In financial terms with 7 machines, 7 days and a $30 (˜average purchase amount per customer for larger UK chains) purchase per customer theoretically the return potential rises from $ 12.230.400,—to $ 73.382.400,—with the improved system. One can thus state that without making sure that all customers scan and bag the benefit and resources used implementing the scanning systems are partly wasted as paying is the quickest process while handling of the goods takes the longest time.

Another improvement that follows as customers use the process improvement is that less space is needed this arises from the fact that there is not a space needed for putting goods in bags and the cashier stations are no longer needed as the utilization rate for scanning customers goes up. Also the need for a queuing space is reduced as the customer handling capacity increases. This reduced space and increased convenience has financial benefits as well. E.g. In a small 4 cashier store the saved cashier space represents $5000 less rent a month alternatively a reduction in the store purchase price, particularly important for stores in areas where there is little space available i.e. cities. If one further assumes that the increased convenience brings 10 (10 $ profit each) more shoppers per day the financial benefits from this for 1 year are $60.000,—in space savings and a $33.600,—profit through more customers. In addition the product represents the most ecological solution emphasizing the dual use of the shopping bag, i.e. using the shopping bag as a garbage bag as well. Especially with the new biodegradable bags this is the most efficient solution. All other solutions lead to multiple bag purchases. When looking at merchandize in stores they are almost entirely wrapped in some kind of plastic, with biodegradable bags at least that part becomes more ecological. And let's not forget that charging for the most ecological bag is a profitable ordeal as well. Making 10 cents per bag returns the following during a year if a store has 20.000 customers per week and each customer buys 1 bag then 1 store has bag revenues of 104.000,—per year. 200 stores thus receive a combined bag revenue of 20,800.000,—per year. A store or a chain can thus increase revenue a great deal in the most ecological way. A paper bag is not very suitable for garbage due to moist intolerance and unselability resulting in bacteria, odour and handling problems.

Using self check out stations (Another variant for replacing cashier stations.) takes 20% longer than normal cashiering meaning that this solution offers good value compared to all other solutions. The options are larger today as scanning is also offered by the new mobile phones reducing costs for the store.

### BRIEF SUMMARY OF THE INVENTION

The process is perfect for hand, mobile or other scanning solution eg. RFID. The invention and product form a process enhancement with which one in a simple way can guide the customer in order to increase profits. The products “mission” is to provide 1 alternative for the customer so as to make the scanning as effective as possible. Whether the customer came with a bag or not it encourages her to scan no matter whether she uses a cart or basket. The scanning is not as utilized as it could be. By making the scanning as utilized as possible one apart from gaining some financial advantages facilitate resources. This is the meaning with scanning and it can be improved like this.

The idea with scanning is to effectivise the store.

The profit increase can happen in the following way: Lesser space needed in the store (less rent/more products), 6 times faster shopping than normal-→more customers, more customers in the store through increased convenience, effectivising bag sales, increasing scanning utilization, possibility to run internal and external advertisement campaigns on the product, the product represents the most ecological solution emphasizing the dual use of the shopping bag, i.e. using the shopping bag as a garbage bag. Further the customers shopping is not limited by a brought along bag from home. Ref research on peoples habits and their effects on behavior*. *If the customer brings a certain bag from home the customer is inclined by habit to plan the shopping according to the bag. This can hinder spur of the moment purchases or other purchases brought on by sales and advertisement in the store that would not suit the brought along bag. This is important as the store is apart from a “large warehouse” also a place where advertising and influence is possible to greater extent than for example through online sales.

In addition the product offers one coherent solution for all occasions and fitting to all or most baskets and carts making sure the process always functions smoothly. The product fits with carts and baskets guiding the customer to always function in the most efficient way. Scan, Bag and Go. The suitable bags are paper, plastic, biodegradable, and recyclable or a normal canvas bag and so on. This brings financial value added to the store and increased convenience for the customer. For example using biodegradable bags is ecological as the same bag can be used and is suitable for shopping and as a garbage bag. A paper bag is not very suitable for garbage due to moist intolerance and unselability resulting in bacteria, odour and handling problems. When one looks around in a store nearly every single piece of merchandise is wrapped in plastic this way at least the bag material is biodegradable and recyclable.

Most importantly the customer is always ready to exit the store straight away which is the goal that leads to more convenience and thus more economic value for everyone.

### BRIEF DESCRIPTION OF THE SEVERAL VIEWS OF THE DRAWING

FIG. 1. 2 stacked pull baskets with bag holders and attached bags.

FIG. 2. 1 Carry basket and 1 pull basket with bag holders attached and filled bags.

FIG. 3. 1 pull basket with attached and filled bag.

FIG. 4. 1 pull basket and bag holder with a stack of bags attached.

FIG. 5. 2 stacked pull baskets with attached bags and bag holder.

FIG. 6. 2 pull baskets with bag holders visible.

FIG. 7. 3 stacked carry baskets with bag holders.

FIG. 8. 3 stacked carry baskets with bag holders.

FIG. 9. 2 stacked carry baskets with bag holders and bags.

FIG. 10. Cart with bag holder in the front.

FIG. 11. Stacked cart with bag holder and aft cart part in a lifted position.

FIG. 12. Bag holder on the side of the cart.

FIG. 13. Space savings in store from improvement, grey area.

FIG. 14. 2 bag holders.

FIG. 15. Bolt, nut and plate usable as bag holder attachment.

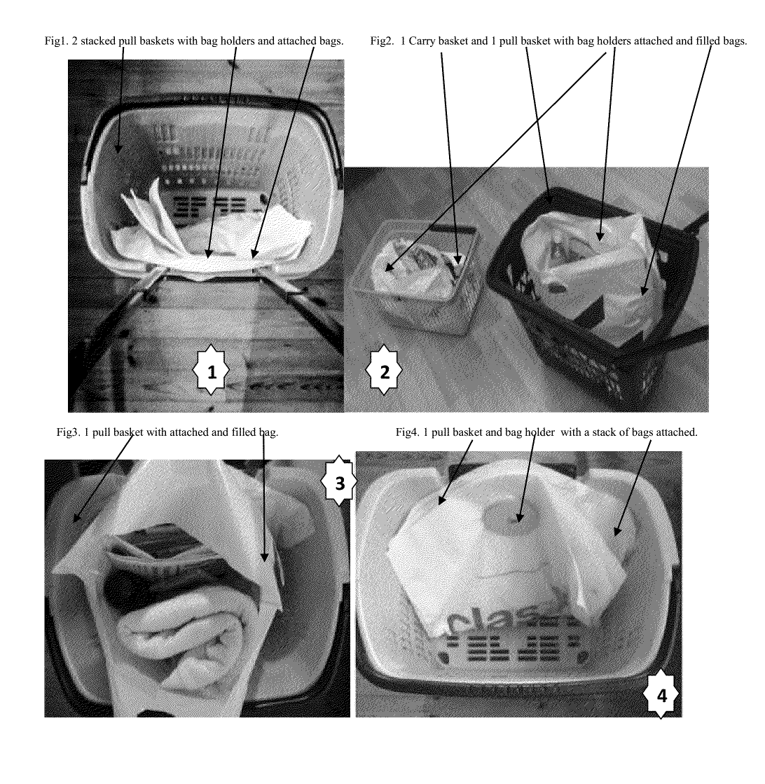

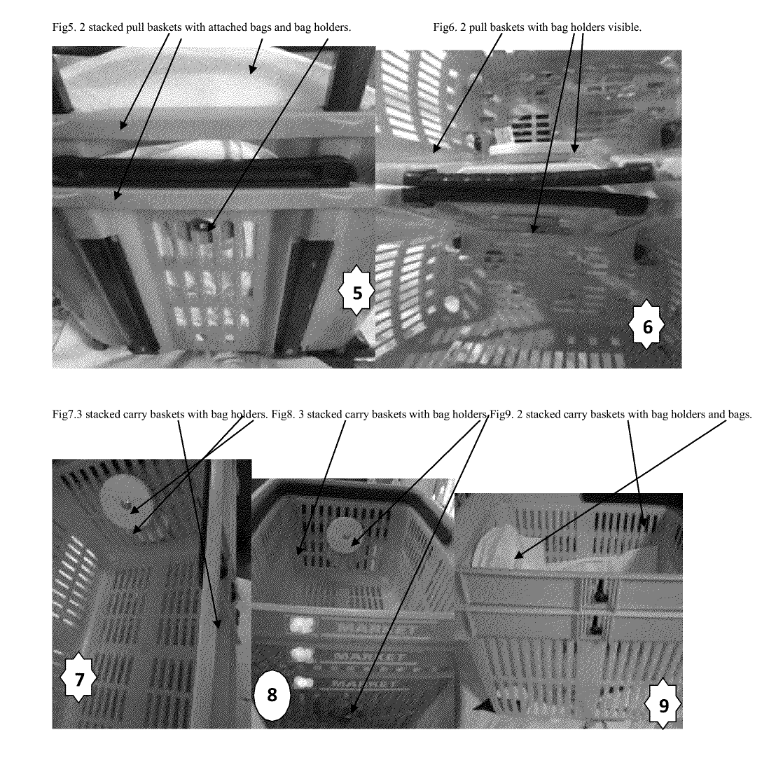

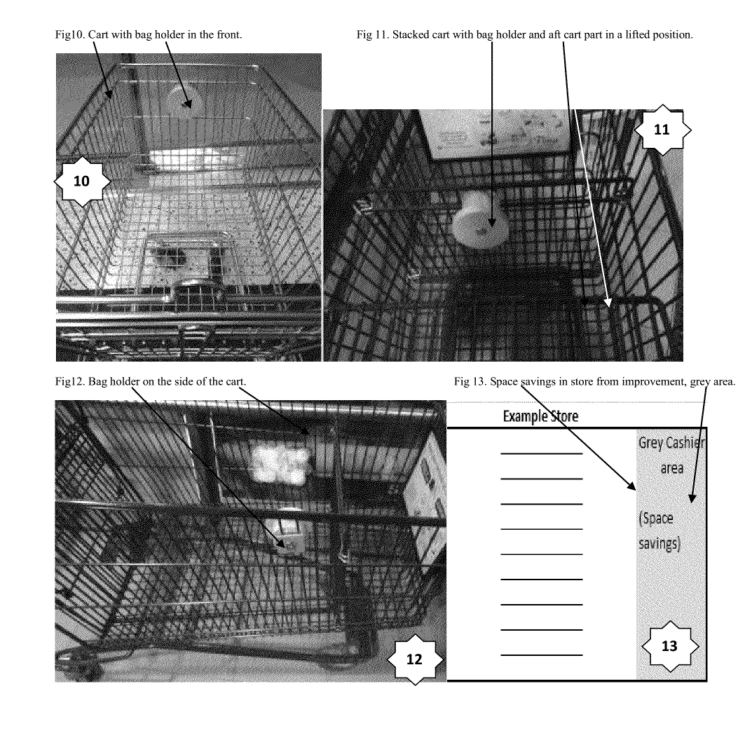

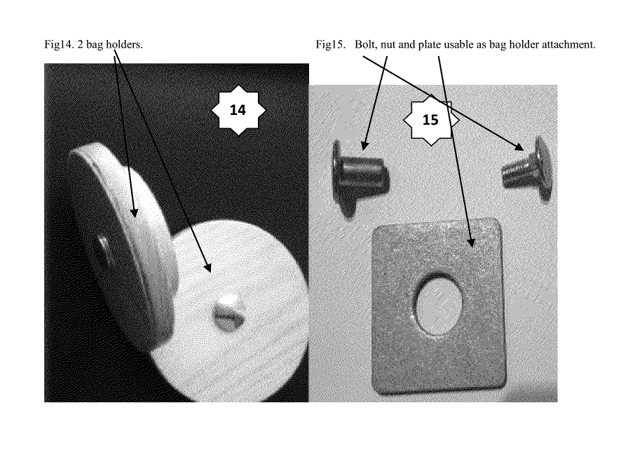

### DETAILED DESCRIPTION OF THE INVENTION

The invention and product form a process enhancement with which one in a simple way can guide the customer in order to increase profits in stores that utilize self, mobile or other type of automated scanning Shopping bags are attached to a bagholder product that attaches to a stores all baskets and carts simplifying things. Shopping bags are hanged on the bagholder product inside the carts and baskets ready to be used by customers. The bagholder product also carries the bags when the carts and baskets are stacked and or not in use. When the bags run out a person fills the carts and baskets with more bags. The customer can pay for the bags via the scanning device. The larger scale or mass produced product is/can be industrially made from polyamide plastic (Cost effectively produced using a plastic mold). The inventor has organized the industrial production of a bagholder part. It is important to determine the right size of the bagholder product so that it fits with the bags, carts and baskets. The bagholder product can be held in place by a nut going through the hole in the bagholder products wider end and attaches to the cart or basket with a standardized bolt and possibly a plate if needed. The products end form is round so that it is more bump safe if for example children play inside the cart.

One does not always know exactly how much one will buy, thus the bags must be conveniently at hand. This will also effectivise the bag usage, i.e. no spill. This is true for both larger country stores as well as for tighter city stores where the relative gain can be much larger. The product leads to space savings, increased speed (6 times faster than the normal way)->lesser queues, more customers, more customers due to convenience, increased scanning utilization, an ecological alternative, freeing up resources and perhaps more bag revenue and so on. It completes the process improvement in other words. Hence the value gained is much larger than might seem plausible at first. Using self check out stations (Another variant for replacing cashier stations.) takes 20% longer than normal cashiering meaning that this solution offers good value compared to all other solutions. The options are larger today as scanning is also offered by the new mobile phones reducing costs for the store. Another factor in favor of the process and bagholder product is that if you do not pack the goods with the help of the bagholder while shopping some of the advantages gained self scanning are not capitalized as paying is the quickest function and packing takes the longest time.

1. The process of pre attaching bags to a Bagholder part that continuously holds, supports and helps in keeping open shopping bags when loading, within all carts, baskets and similar transporting equipment in stores when they are in use and when they are idle or stacked ready to be used at all times by the customer if the customer so wishes during shopping with a scanning device, RFID or similar system in use at the store effectivising and improving the scanning function, the store profitability and the customer experience in a very if not even the most ecological way.
